(19) United States
(12) Patent Application Publication
(10) Pub. No.: US 2026/0318185 A1
(43) Pub. Date: Oct. 15, 2026

(54) SYSTEMS AND METHODS FOR MODELING GAS-INDUCED ASPHALTENE EVOLUTION IN SUBSURFACE RESERVOIRS

(71) Applicant: Schlumberger Technology Corporation, Sugar Land, TX (US)

(72) Inventors: Tarek Mohamed, Sugar Land, TX (US); Morten Kristensen, Lysaker (NO); Oliver C. Mullins, Houston, TX (US)

(21) Appl. No.: 19/642,396

(22) Filed: Apr. 8, 2026

Related U.S. Application Data
(60) Provisional application No. 63/788,253, filed on Apr. 14, 2025.

(51) Int. Cl. E21B 47/00; E21B 44/00; G01V 20/00

(52) U.S. Cl. CPC E21B 47/006; E21B 44/00; G01V 20/00; E21B 2200/20

(57) ABSTRACT

Systems and methods for modeling gas-induced asphaltene evolution in subsurface reservoirs are provided. A computer-implemented method for predicting asphaltene cluster gradients in a subsurface reservoir (SR) includes: inputting, into a compositional reservoir simulation model (CRSM), reservoir data for an SR, establishing a fluid charge sequence with a petroleum system model, representing gas addition to an oil column over geologic time, establishing a forward model charge sequence in the CRSM that accounts for conversion of asphaltene nanoaggregates to asphaltene clusters, obtaining, from the CRSM, a prediction of asphaltene cluster gradients, comparing the prediction of the asphaltene cluster gradients to an established data set, using results of the comparing to predict fluid distribution characteristics (FDCs) of the SR, and based at least in part on the predicted FDCs: generating drilling parameters for drilling in the SR, and operating drilling equipment to drill in accordance with the drilling parameters to retrieve desired fluids.

### CROSS-REFERENCE TO RELATED APPLICATIONS

This application claims the benefit of and priority to U.S. Provisional Application No. 63/788,253, filed on Apr. 14, 2025, the entirety of which is incorporated herein for all purposes.

### TECHNICAL FIELD

This disclosure generally relates to systems and methods for modeling gas-induced asphaltene evolution in subsurface reservoirs.

### BACKGROUND

Subsurface hydrocarbon reservoirs contain complex fluid systems whose compositions and properties may vary spatially as a result of geological structure, gravity, diffusion, and long-term charge processes. Crude oils commonly include asphaltenes, which are among the heaviest hydrocarbon fractions and may exist in multiple forms within reservoir fluids. Variations in the presence and distribution of asphaltenes may influence fluid properties such as viscosity, density, and phase behavior, and may therefore affect reservoir performance, production strategies, and field development planning.

Reservoir simulation techniques are widely used to model fluid flow and pressure behavior within subsurface formations and often represent oil, gas, and water using compositional or black-oil modeling approaches. Petroleum system modeling may be used to evaluate hydrocarbon generation and charge history; however, such models are often implemented separately from reservoir-scale simulations. As a result, existing workflows may provide limited insight into changes in reservoir fluid composition associated with gas addition over geologic time, including gas-induced changes in asphaltene behavior and their potential impact on fluid property gradients within a reservoir.

Accordingly, there is a need for systems and methods for modeling gas-induced asphaltene evolution in subsurface reservoirs.

### SUMMARY

This disclosure pertains to systems and methods for modeling gas-induced asphaltene evolution in subsurface reservoirs.

A first aspect of this disclosure pertains to a computer-implemented method for predicting asphaltene cluster gradients in a subsurface reservoir, the method including: inputting, into a compositional reservoir simulation model, reservoir data for a subsurface reservoir, the reservoir data including one or more of: seismic data, a geology log, a petrophysical log, a core sample, a fluid sample, or a pressure test, establishing a fluid charge sequence with input from a petroleum system model, the fluid charge sequence representing gas addition to an oil column over geologic time, establishing a forward model charge sequence in the compositional reservoir simulation model that accounts for conversion of asphaltene nanoaggregates to asphaltene clusters resulting from an increase in solution gas concentration, obtaining, from the compositional reservoir simulation model, a prediction of one or more asphaltene cluster gradients in the subsurface reservoir, comparing the prediction of the one or more asphaltene cluster gradients to an established data set including observed data, using results of the comparing to predict one or more fluid distribution characteristics of the subsurface reservoir, and based at least in part on the predicted one or more fluid distribution characteristics: generating drilling parameters for drilling in the subsurface reservoir, and operating drilling equipment to drill in the subsurface reservoir in accordance with the drilling parameters to retrieve desired fluids in the subsurface reservoir at one or more locations indicated by the predicted one or more fluid distribution characteristics.

A second aspect of this disclosure pertains to the computer-implemented method of the first aspect, wherein: the establishing the forward model charge sequence includes coupling the conversion of asphaltene nanoaggregates to asphaltene clusters with a diffusion mechanism based on a chemical potential of components in the compositional reservoir simulation model, and the chemical potential accounts for gravity such that heavier asphaltene cluster components migrate toward a base of the oil column.

A third aspect of this disclosure pertains to the computer-implemented method of the first aspect, wherein: the gas addition includes adding methane to the oil column, and the conversion of asphaltene nanoaggregates to asphaltene clusters is triggered when a methane mole fraction reaches a threshold amount locally in the subsurface reservoir.

A fourth aspect of this disclosure pertains to the computer-implemented method of the first aspect, wherein the establishing the fluid charge sequence includes modeling biogenic gas being added at an oil-water contact (OWC) into the oil column over a scaled duration of at least about 100,000 years.

A fifth aspect of this disclosure pertains to the computer-implemented method of the fourth aspect, wherein: the compositional reservoir simulation model tracks changes in at least one of solution gas-oil ratio (GOR), oil saturation, or gas saturation over the scaled duration, and the model predicts formation of a separate gas phase, including a gas cap, after an oil phase becomes saturated with gas.

A sixth aspect of this disclosure pertains to the computer-implemented method of the first aspect, wherein using the results of the comparing to predict the one or more fluid distribution characteristics includes predicting at least one of: a distribution of asphaltene content, or a distribution of oil viscosity in the subsurface reservoir based on observed measurements of gas-oil ratio (GOR).

A seventh aspect of this disclosure pertains to the computer-implemented method of the first aspect, wherein the reservoir data is applied to a reservoir model representing a tilted-sheet sandstone reservoir, the reservoir model including: a top portion initially saturated with dead oil, and a bottom portion including a water aquifer.

An eighth aspect of this disclosure pertains to one or more non-transitory computer-readable media storing instructions that, when executed by at least one processor of a computing system, cause the computing system to perform operations for predicting asphaltene cluster gradients in a subsurface reservoir, the operations including: inputting, into a compositional reservoir simulation model, reservoir data for a subsurface reservoir, the reservoir data including one or more of: seismic data, a geology log, a petrophysical log, a core sample, a fluid sample, or a pressure test, establishing a fluid charge sequence with input from a petroleum system model, the fluid charge sequence representing gas addition to an oil column over geologic time, establishing a forward model charge sequence in the compositional reservoir simulation model that accounts for conversion of asphaltene nanoaggregates to asphaltene clusters resulting from an increase in solution gas concentration, obtaining, from the compositional reservoir simulation model, a prediction of one or more asphaltene cluster gradients in the subsurface reservoir, comparing the prediction of the one or more asphaltene cluster gradients to an established data set including observed data, using results of the comparing to predict one or more fluid distribution characteristics of the subsurface reservoir, and based at least in part on the predicted one or more fluid distribution characteristics: generating drilling parameters for drilling in the subsurface reservoir, and operating drilling equipment to drill in the subsurface reservoir in accordance with the drilling parameters to retrieve desired fluids in the subsurface reservoir at one or more locations indicated by the predicted one or more fluid distribution characteristics.

A ninth aspect of this disclosure pertains to the one or more non-transitory computer-readable media of the eighth aspect, wherein: the establishing the forward model charge sequence includes coupling the conversion of asphaltene nanoaggregates to asphaltene clusters with a diffusion mechanism based on a chemical potential of components in the compositional reservoir simulation model, and the chemical potential accounts for gravity such that heavier asphaltene cluster components migrate toward a base of the oil column.

A tenth aspect of this disclosure pertains to the one or more non-transitory computer-readable media of the eighth aspect, wherein: the gas addition includes adding methane to the oil column, and the conversion of asphaltene nanoaggregates to asphaltene clusters is triggered when a methane mole fraction reaches a threshold amount locally in the subsurface reservoir.

An eleventh aspect of this disclosure pertains to the one or more non-transitory computer-readable media of the eighth aspect, wherein: the establishing the fluid charge sequence includes modeling biogenic gas being added at an oil-water contact (OWC) into the oil column over a scaled duration of at least about 100,000 years, the compositional reservoir simulation model tracks changes in at least one of solution gas-oil ratio (GOR), oil saturation, or gas saturation over the scaled duration, and the model is configured to predict formation of a separate gas phase, including a gas cap, after an oil phase becomes saturated with gas.

A twelfth aspect of this disclosure pertains to the one or more non-transitory computer-readable media of the eighth aspect, wherein using the results of the comparing to predict the one or more fluid distribution characteristics includes predicting at least one of: a distribution of asphaltene content, or a distribution of oil viscosity in the subsurface reservoir based on observed measurements of gas-oil ratio (GOR).

A thirteenth aspect of this disclosure pertains to the one or more non-transitory computer-readable media of the eighth aspect, wherein the reservoir data is applied to a reservoir model representing a tilted-sheet sandstone reservoir, the reservoir model including: a top portion initially saturated with dead oil, and a bottom portion including a water aquifer.

A fourteenth aspect of this disclosure pertains to a system, including: one or more processors, and at least one memory including at least one non-transitory computer-readable medium storing instructions that, when executed by at least one of the one or more processors, cause the system to perform operations for predicting asphaltene cluster gradients in a subsurface reservoir, the operations including: inputting, into a compositional reservoir simulation model, reservoir data for a subsurface reservoir, the reservoir data including one or more of: seismic data, a geology log, a petrophysical log, a core sample, a fluid sample, or a pressure test, establishing a fluid charge sequence with input from a petroleum system model, the fluid charge sequence representing gas addition to an oil column over geologic time, establishing a forward model charge sequence in the compositional reservoir simulation model that accounts for conversion of asphaltene nanoaggregates to asphaltene clusters resulting from an increase in solution gas concentration, obtaining, from the compositional reservoir simulation model, a prediction of one or more asphaltene cluster gradients in the subsurface reservoir, comparing the prediction of the one or more asphaltene cluster gradients to an established data set including observed data, using results of the comparing to predict one or more fluid distribution characteristics of the subsurface reservoir, and based at least in part on the predicted one or more fluid distribution characteristics: generating drilling parameters for drilling in the subsurface reservoir, and operating drilling equipment to drill in the subsurface reservoir in accordance with the drilling parameters to retrieve desired fluids in the subsurface reservoir at one or more locations indicated by the predicted one or more fluid distribution characteristics.

A fifteenth aspect of this disclosure pertains to the system of the fourteenth aspect, wherein: the establishing the forward model charge sequence includes coupling the conversion of asphaltene nanoaggregates to asphaltene clusters with a diffusion mechanism based on a chemical potential of components in the compositional reservoir simulation model, and the chemical potential accounts for gravity such that heavier asphaltene cluster components migrate toward a base of the oil column.

A sixteenth aspect of this disclosure pertains to the system of the fourteenth aspect, wherein: the gas addition includes adding methane to the oil column, and the conversion of asphaltene nanoaggregates to asphaltene clusters is triggered when a methane mole fraction reaches a threshold amount locally in the subsurface reservoir.

A seventeenth aspect of this disclosure pertains to the system of the fourteenth aspect, wherein the establishing the fluid charge sequence includes modeling biogenic gas being added at an oil-water contact (OWC) into the oil column over a scaled duration of at least about 100,000 years.

An eighteenth aspect of this disclosure pertains to the system of the seventeenth aspect, wherein: the compositional reservoir simulation model tracks changes in at least one of solution gas-oil ratio (GOR), oil saturation, or gas saturation over the scaled duration, and the model is configured to predict formation of a separate gas phase, including a gas cap, after an oil phase becomes saturated with gas.

A nineteenth aspect of this disclosure pertains to the system of the fourteenth aspect, wherein using the results of the comparing to predict the one or more fluid distribution characteristics includes predicting at least one of: a distribution of asphaltene content, or a distribution of oil viscosity in the subsurface reservoir based on observed measurements of gas-oil ratio (GOR).

A twentieth aspect of this disclosure pertains to the system of the fourteenth aspect, wherein the reservoir data is applied to a reservoir model representing a tilted-sheet sandstone reservoir, the reservoir model including: a top portion initially saturated with dead oil, and a bottom portion including a water aquifer.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description that follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF DRAWINGS

To describe the manner in which the above-recited and other features of the disclosure can be obtained, a more particular description will be rendered by reference to specific implementations thereof, which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings.

FIG. 1 is a schematic view illustrating an example of a geologic environment.

FIG. 2 is a workflow diagram of a method of predicting oil reservoir asphaltene cluster gradients according to an example embodiment of the present disclosure.

FIG. 3 is a graph constructed according to an example embodiment of the present disclosure.

FIG. 4 is a set of graphs illustrating an initial compositional state of a reservoir focusing on changing mole fraction of three components according to an example embodiment of the present disclosure.

FIG. 5 is a set of graphs illustrating an initial compositional state of a reservoir focusing on changing mole fraction of three components of tracking interest according to an example embodiment of the present disclosure.

FIG. 6 is a set of graphs illustrating a biogenic gas being added at an oil-water contact (OWC) into the oil reservoir according to an example embodiment of the present disclosure.

FIG. 7 is a set of graphs illustrating a relationship between an added biogenic methane and a dynamical conversion of asphaltene nanoaggregates into clusters according to an example embodiment of the present disclosure.

FIG. 8 is a flowchart for an example method.

FIG. 9 illustrates certain components that may be included within a computer system according to an example embodiment of the present disclosure.

Before explaining the disclosed embodiment of this disclosure in detail, it is to be understood that the disclosure is not limited in its application to the details of the particular arrangements shown, as the disclosure is capable of other embodiments. Example embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

While the subject disclosure applies to embodiments in many different forms, specific embodiments are shown in the drawings and will be described in detail herein with the understanding that the present disclosure is an example of the principles of the disclosure. It is not intended to limit the disclosure to the specific illustrated embodiments. The features of the disclosure herein in the description, drawings, and claims can be significant, both individually and in any desired combinations, for the operation of the disclosure in its various embodiments. Features from one embodiment can be used in other embodiments of the disclosure. In the description of the drawings, like reference numerals refer to like elements.

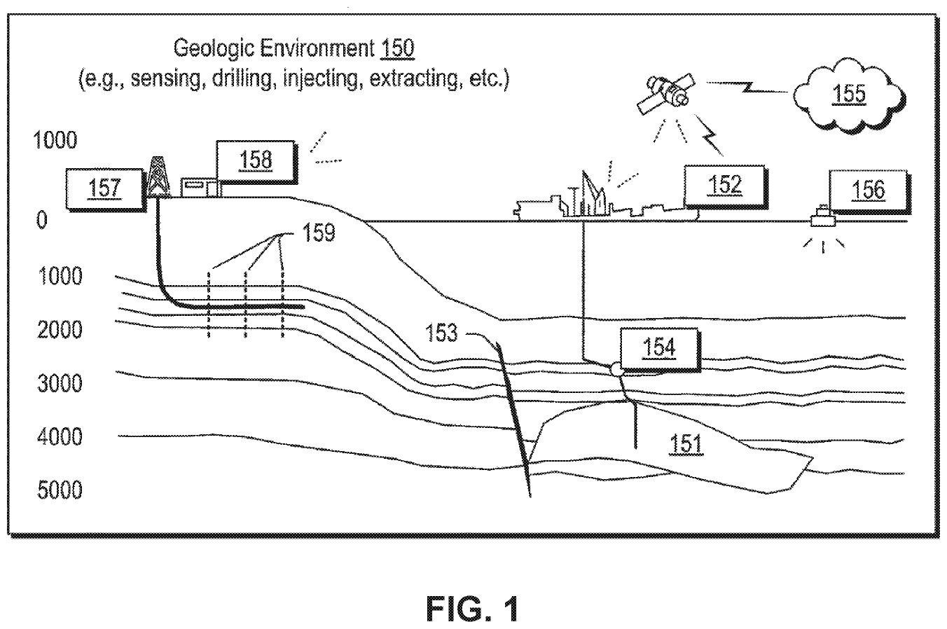

FIG. 1 is a schematic view illustrating an example of a geologic environment.

In the example of FIG. 1, an example geologic environment 150 may include layers (e.g., stratification) that may include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be, for example, equipment to acquire information, equipment to assist with resource recovery, etc. Other equipment 156 may be located remote from a wellsite and include sensing, detecting, emitting, or other circuitry. Such equipment may include, for example, storage and communication circuitry to store and to communicate data, instructions, etc. As an example, one or more satellites may be provided for purposes of communications, data acquisition, etc. For example, FIG. 1 shows a satellite in communication with the one or more networks 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures), or a combination of natural and artificial fractures. As an example, a well may be drilled at a wellsite for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

Asphaltenes are hydrocarbon fractions insoluble in n-heptane and soluble in toluene. Generally, asphaltenes are heavy polycyclic aromatic compounds that typically exist in oils as suspended and/or dispersed nanocolloidal particles, representing the oils'heaviest components with the lowest effective diffusion coefficients, but can often be involved with density inversions and convection.

It may be appreciated that gravitational forces have the greatest impact on asphaltene distributions in crude oils. According to the Yen-Mullins model, asphaltenes are typically suspended and/or dispersed in crude oils in three different forms: molecules (~1 nm), nanoaggregates of molecules (~2 nm), and clusters of nanoaggregates (~5 nm). The asphaltene concentration in crude oil largely governs the corresponding asphaltene forms. The solvation properties of crude oil, including solution gas oil ratio (GOR) and saturate, aromatic, resin, and asphaltene fractions (SARA), also play an important role in asphaltene speciation. For example, as the concentration of asphaltenes in oils increases, the form of the asphaltenes changes from dissolved molecules for the lowest concentrations (in light oil) to dispersed nanoaggregates for medium concentrations (in black oil), to suspended clusters for the highest concentrations (in heavy oil and destabilized black oil). Dispersed asphaltenes in black oil can be destabilized due to gas charge, which leads to a transition of the colloidal structure of some nanoaggregates and the coexistence of asphaltene nanoaggregates and clusters. This change initiates higher-than-expected viscosity gradients, and the continued instability can result in asphaltene deposition and/or the formation of tar mats.

In accordance with the present disclosure, a compositional reservoir simulation model is utilized to model the conversion of asphaltene nanoaggregates to clusters, resulting from the solution gas increase. That is, asphaltene destabilization occurs, and asphaltene nanoaggregates start to convert to asphaltene clusters once the solution gas concentration exceeds a specific value. This conversion is coupled with a diffusion mechanism in the model based on the chemical potential of the components, where the chemical potential accounts for gravity. Driven by the gradient in chemical potential, the heavier asphaltene cluster components migrate to the base of the oil column, forming the characteristic asphaltene concentration gradient observed in many oil fields. These coupled processes of nanoaggregate conversion to clusters and migration in the oil column are captured by the disclosed modeling technique.

Potential uses of the presently disclosed embodiments include using observed measurements of gas-oil ratio (GOR) to predict asphaltene nanoaggregate and cluster gradients. That is, the disclosed technique can be used to leverage GOR measurements to predict the distributions of other in-situ oil properties: asphaltene content and oil viscosity. Then, these predictions can be expanded to undrilled regions of the oil field to predict the properties of oil in place prior to drilling.

Asphaltenes in black oil reservoirs are expected to exist in the form of nanoaggregates. However, gas charge into black oil may result in destabilization of asphaltenes, leading to the conversion of some or all asphaltene nanoaggregates to asphaltene clusters and the subsequent migration of asphaltene clusters toward the base of the oil column. In many black oil reservoirs, asphaltene cluster gradients were measured along with relatively high solution gas amounts. Reservoir numerical simulators have never been able to account for the expulsion of asphaltenes from the top of the oil column and their migration to the base of the oil column. Nevertheless, the loss of asphaltenes from the top of the column would impact critical constants and phase behavior.

In accordance with the present embodiments, a new method for modeling the effect of gas addition on the asphaltenes deposition geodynamics is disclosed. That is, using a reservoir simulator, e.g., ECLIPSE®, we account for asphaltene migration in the oil column resulting from solution gas increase, which would impact oil viscosity, effective critical constants, and phase behavior.

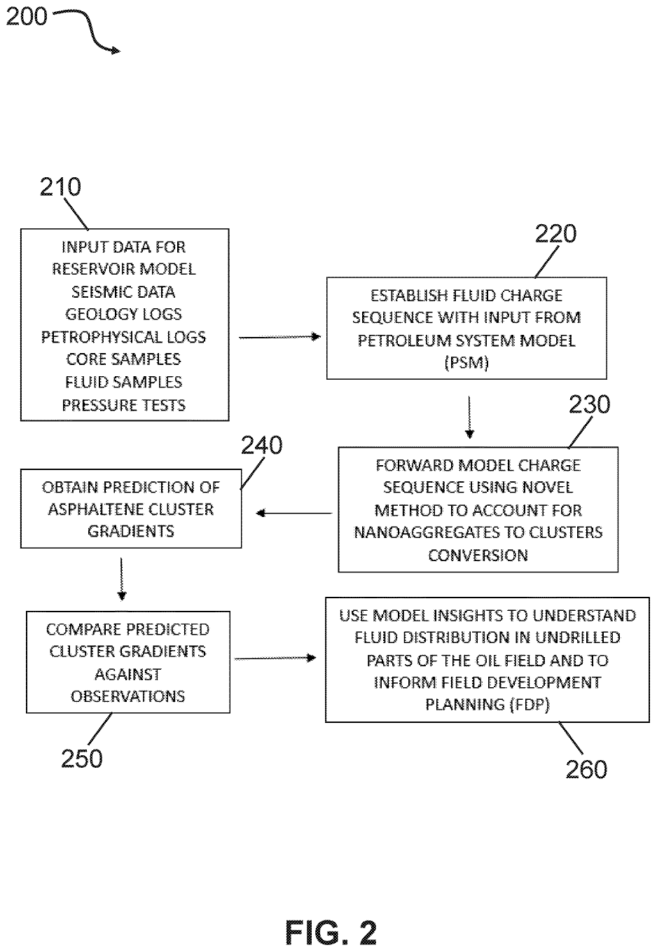

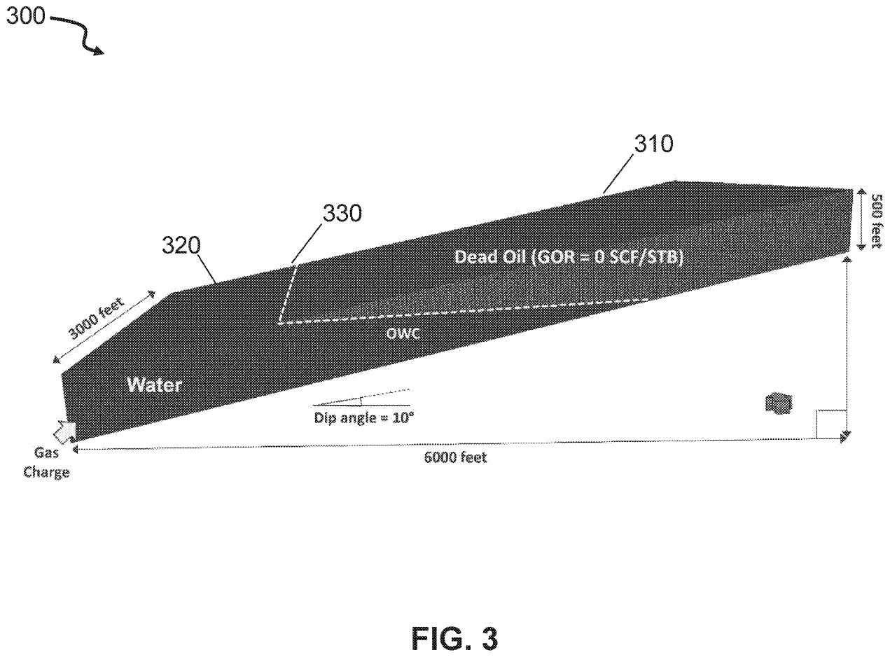

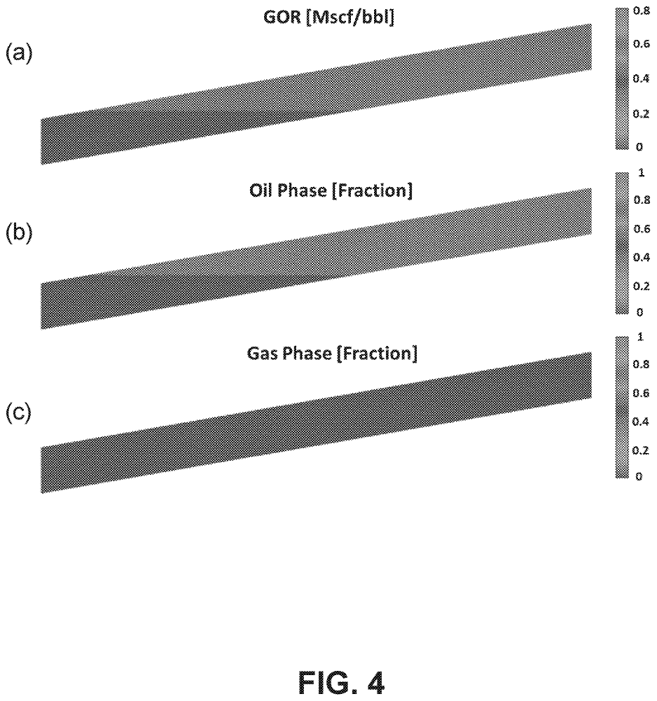

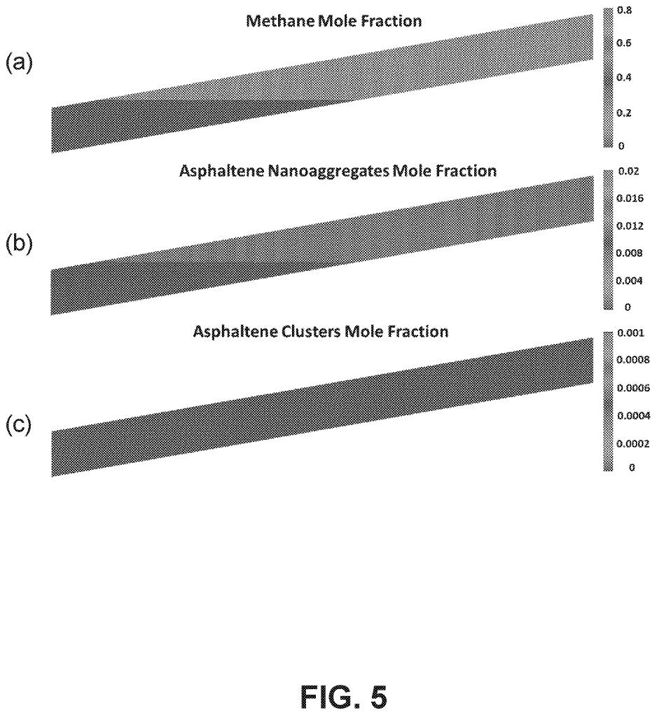

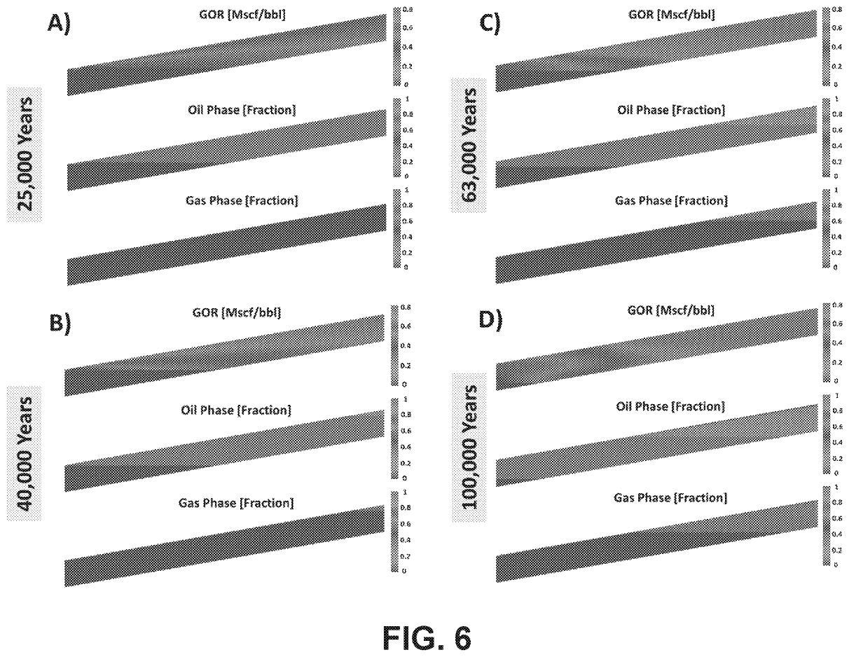

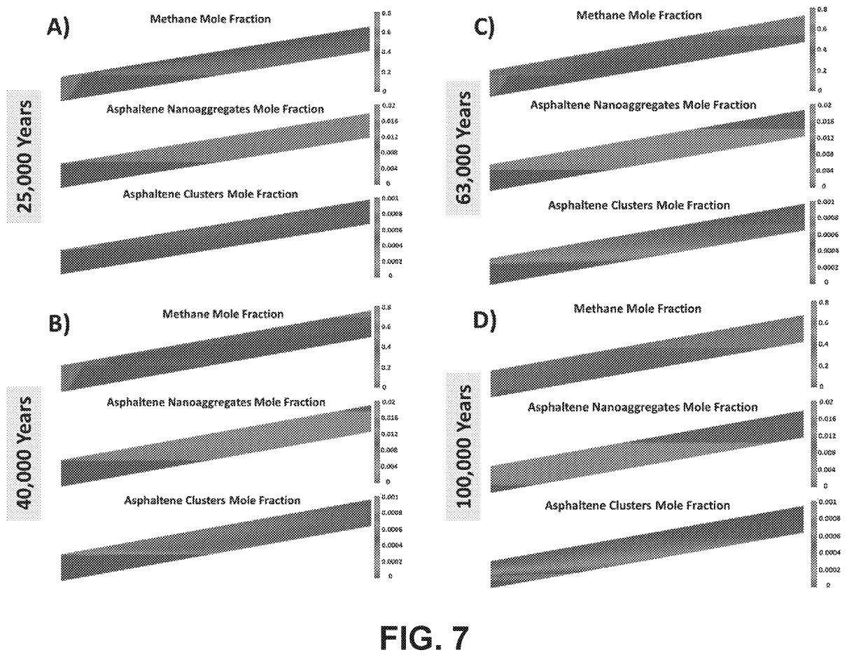

FIG. 2 is a workflow diagram of a method of predicting oil reservoir asphaltene cluster gradients according to an example embodiment of the present disclosure. FIG. 3 is a graph constructed according to an example embodiment of the present disclosure. FIG. 4 is a set of graphs illustrating an initial compositional state of a reservoir focusing on changing mole fraction of three components according to an example embodiment of the present disclosure. FIG. 5 is a set of graphs illustrating an initial compositional state of a reservoir focusing on changing mole fraction of three components of tracking interest according to an example embodiment of the present disclosure. FIG. 6 is a set of graphs illustrating a biogenic gas being added at an oil-water contact (OWC) into an oil reservoir according to an example embodiment of the present disclosure. FIG. 7 is a set of graphs illustrating a relationship between the added biogenic methane and the dynamical conversion of asphaltene nanoaggregates into clusters according to an example embodiment of the present disclosure.

FIG. 2 illustrates a workflow showing primary operations of an example method 200 for predicting oil reservoir asphaltene cluster gradients. The example method 200 may include, at 210, inputting data into a reservoir model, the data including seismic data, geology logs, petrophysical logs, core samples, fluid samples, and pressure tests. The example method 200 may further include, at 220, establishing a fluid charge sequence with input from a petroleum system model. The example method 200 may further include, at 230, using a forward model charge sequence to account for a conversion of nanoaggregates to clusters. The example method 200 may further include, at 240, obtaining a prediction of asphaltene cluster gradients. The example method 200 may further include, at 250, comparing predicted cluster gradients against observed data. The example method 200 may further include, at 260, using model insights to understand fluid distribution in undrilled parts of the oil field and to inform field development planning. The example method 200 may result in enhancing the understanding of reservoir fluid distribution and, thereby, the field development strategy that should be implemented.

In some embodiments, the forward model charge sequence may be configured as a predictive simulation in which reservoir fluids may be forecast from an initial state at the time of hydrocarbon charge to a present-day state over geologic time. Conventional reservoir simulation is normally limited to production timelines (e.g., about 10-20 years), whereas the disclosed technique extends fluid-mechanics-based simulation over geologic time. Geologic time may be, for example, at least about 100,000 years, although about 1,000,000 years may be typical, and even larger time periods, such as about 10,000,000 years, may be contemplated and modeled. Unlike inverse or history-matching approaches that infer past conditions from present-day measurements, the forward modeling approach described herein advances fluid composition and distribution forward in time using fluid mechanics and thermodynamic principles. This predictive approach may enable evaluation of how reservoir architecture and fluid connectivity influence present-day asphaltene cluster gradients and fluid distributions.

In accordance with some embodiments, a reservoir simulation model based on fluid mechanics may be employed over geologic time scales, rather than being limited to conventional production timelines. While reservoir simulation models are typically used to evaluate fluid flow during hydrocarbon production, the disclosed embodiments apply fluid mechanics modeling to simulate fluid evolution within the reservoir from the time of hydrocarbon charge to present day. This extension enables the prediction of present-day asphaltene cluster gradients and fluid distributions resulting from long-term thermodynamic and gravitational processes, and may provide predictions over a larger area of a reservoir based on measurements taken from a small area or location.

In some embodiments, agreement or disagreement between predicted asphaltene cluster gradients and observed data may be used to assess reservoir-scale connectivity. For example, differences in predicted and observed fluid properties across spatial locations may indicate the presence of flow barriers, baffles, or compartmentalization within the reservoir.

A correspondence between predicted gradients and observed gradients does not, by itself, establish reservoir connectivity. Rather, such correspondence indicates that the geological scenario represented in the forward model constitutes a plausible scenario in which, when fluid charge is simulated, the resulting predicted fluid distribution is consistent with the observed data. Whether the reservoir is connected or exhibits barriers or compartmentalization depends on the particular geological scenario incorporated into the forward model, including the assumed reservoir architecture and properties, rather than on the existence of a match between predicted and observed gradients alone. Such assessments enable differentiation between connected reservoirs and reservoirs exhibiting restricted connectivity, which can significantly influence subsequent drilling and development decisions.

In some embodiments, discrepancies between predicted asphaltene cluster gradients and observed data may be used to identify uncertainties in one or more of the assumed reservoir architecture, fluid charge sequence, or forward model parameters. Based on such discrepancies, one or more aspects of the reservoir model may be revised and the forward modeling repeated. This iterative process allows refinement of the reservoir representation prior to drilling or production activities, thereby reducing uncertainty associated with subsurface conditions.

FIG. 3 illustrates a Cartesian grid corresponding to an example reservoir 300 of size 200×1×50 (X×Y×Z directions) constructed using the presently disclosed method, where the grid cells have dimensions of 30×3000×10 (feet). The example reservoir 300 is a tilted-sheet sandstone with a 10° dip angle. Similar to a flat model, a top half 310 of the reservoir is initially saturated with dead oil, while a bottom half 320 of the reservoir is a water aquifer. An oil-water contact (OWC) 330 is at a boundary between the top half 310 and the bottom half 320 of the reservoir.

FIG. 4 illustrates an initial state of the reservoir before the onset of gas charge, represented by solution gas-oil ratio (GOR) (“GOR [Mscf/bbl]”) in FIG. 4, part (a), oil saturation (“Oil Phase [Fraction]”) in FIG. 4, part (b), and gas saturation (“Gas Phase [Fraction]”) in FIG. 4, part (c). Initially, the reservoir is fully saturated with only an oil phase with no free gas, and the solution gas-oil ratio is homogeneous throughout the reservoir. The oil reservoir is underlain by a water aquifer.

FIG. 5 illustrates an initial compositional state of the reservoir focusing on changing mole fraction of three components of tracking interest. In this example, these are methane (“Methane Mole Fraction”) in FIG. 5, part (a), asphaltene nanoaggregates (“Asphaltene Nanoaggregates Mole Fraction”) in FIG. 5, part (b), and asphaltene clusters (“Asphaltene Clusters Mole Fraction”) in FIG. 5, part (c). The initial oil contains only asphaltene nanoaggregates, where asphaltene clusters are nonexistent as indicated in the asphaltene clusters panel showing dark color (zero) throughout the oil reservoir and the water aquifer (which remains dark over time).

FIG. 6 illustrates a plot of a biogenic gas, e.g., a primary biogenic gas, being added at the oil-water contact (OWC) into the oil reservoir, over about a 100,000-year (scaled) duration of charge. The changing reservoir fluid state and compositional distributions are tracked. For example, the changing GOR, oil saturation, and gas saturation may be tracked. As illustrated, after about 25,000 years of the onset of gas charge (see FIG. 6, part (a)), all added methane mixes well such that there is still only an oil phase while the GOR increases as a result of added biogenic gas. After about 40,000 years of the onset of gas charge (see FIG. 6, part (b)), the oil phase becomes fully saturated with gas. Thus, any excess added methane gives rise to the formation of a separate gas phase (gas cap) while GOR values increase across the reservoir. After about 63,000 years of the onset of gas charge (see FIG. 6, part (c)), the gas cap size increases as a result of continuing gas addition, and the GOR gradient becomes clear, showing less gas toward the base of the oil column. At the end of about 100,000 years of biogenic gas charge (see FIG. 6, part (d)), the gas cap reaches its maximum size and the water aquifer is mostly pushed outside of the model volume as a result of oil expansion and gas formation.

FIG. 7 illustrates a plot showing the relationship between the added biogenic methane and the dynamical conversion of asphaltene nanoaggregates into clusters. As illustrated, the changing mole fractions of methane, asphaltene nanoaggregates, and asphaltene clusters are tracked. The gas addition in significant amounts, over geologic time, destabilizes the asphaltenes. That is, once methane mole fraction reaches a certain amount locally, e.g., a threshold amount, asphaltene nanoaggregates convert into asphaltene clusters. As shown, at about 25,000 years of scaled time (see FIG. 7, part (a)), some of the asphaltene nanoaggregates have already converted into clusters, as a small amount of clusters has formed, as seen by the light blue on the OWC in the asphaltene clusters panel. At about 40,000 years (see FIG. 7, part (b)), methane mole fraction has increased, which is indicated by the light green color. The gas cap started forming, asphaltene nanoaggregates continue to convert to clusters, more clusters have formed and accumulated on the OWC. At about 63,000 years (see FIG. 7, part (c)), the general conversion trend that was triggered by the gas addition and asphaltenes destabilization continues. Thus, methane fraction increases, and the nanoaggregates concentration decreases while the clusters concentration increases. Finally, at about 100,000 years of scaled charge time (see FIG. 7, part (d)), more asphaltene clusters have formed and accumulated on the OWC. If this process continues, all nanoaggregates will convert to clusters, leading to an asphaltene gradient measured in the case study reservoir.

Example embodiments of the present disclosure may be used to model the effects of gas-induced asphaltene evolution on fluid properties in a subsurface reservoir. Example embodiments may include inputting data into a reservoir model, establishing a fluid charge sequence, using a forward model charge sequence to account for the conversion of nanoaggregates to clusters, obtaining a prediction of asphaltene cluster gradients, comparing predicted cluster gradients against observed data, and using model insights to understand fluid distribution in undrilled parts of the oil field and to inform field development planning.

The reservoir model may be a compositional reservoir simulation model that utilizes a diffusion mechanism based on the chemical potential of the components. The chemical potential may account for gravity, and the diffusion mechanism may be used to model the migration of asphaltene clusters in the oil column. The model may also account for the effects of gas charge on the stability of asphaltenes, including the conversion of nanoaggregates to clusters.

Example embodiments may also include tracking the changing mole fractions of methane, asphaltene nanoaggregates, and asphaltene clusters over time. Example embodiments may be used to leverage gas-oil ratio (GOR) measurements to predict the distributions of other in-situ oil properties, including asphaltene content and oil viscosity. Example embodiments may be implemented using a computer system, including one or more processors and memory, to perform the operations of example embodiments and to store and retrieve data related to the reservoir model and the petroleum system model.

Example embodiments may be used to improve the understanding of reservoir fluid distribution and to inform field development planning. Example embodiments may be used to predict the effects of gas-induced asphaltene evolution on fluid properties, including viscosity and phase behavior, and to identify potential risks and opportunities associated with the development of the reservoir. Example embodiments may be used in conjunction with other reservoir modeling techniques, such as seismic modeling and production modeling, to provide a comprehensive understanding of the reservoir and its behavior over time.

Example embodiments provide systems and techniques for modeling gas-induced asphaltene evolution in subsurface reservoirs. Asphaltene destabilization occurs due to gas charge, leading to conversion of nanoaggregates to clusters, which migrate to the base of the oil column. A compositional reservoir simulation model utilizes a diffusion mechanism based on chemical potential, accounting for gravity. The model predicts asphaltene cluster gradients, leveraging gas-oil ratio measurements to predict distributions of in-situ oil properties, including asphaltene content and oil viscosity. This enables improved understanding of reservoir fluid distribution and informs field development planning, predicting effects of gas-induced asphaltene evolution on fluid properties and identifying potential risks and opportunities.

Example embodiments may receive reservoir data (e.g., seismic data, geology logs, petrophysical logs, core samples, fluid samples, and/or pressure tests), and may execute a compositional reservoir simulation model to establish a fluid charge sequence using input from a petroleum system model. The fluid charge sequence represents gas addition to an oil column over geologic time. Example embodiments may establish a forward model charge sequence that accounts for conversion of asphaltene nanoaggregates to asphaltene clusters resulting from an increase in solution gas concentration, may obtain a prediction of one or more asphaltene cluster gradients, and may compare the predicted cluster gradients to an established data set including observed data.

Based at least in part on results of the comparison and the resulting predicted fluid distribution characteristics, example embodiments may generate drilling parameters for drilling in the subsurface reservoir, and may provide the drilling parameters for use in a drilling operation, including operating drilling equipment to drill in the subsurface reservoir in accordance with the drilling parameters. In some embodiments, the drilling parameters include, for example, one or more of: a target depth, a target interval, a drilling direction, an inclination, an azimuth, a planned wellbore geometry, a wellbore trajectory, e.g., defined to intersect one or more subsurface locations indicated by the predicted fluid distribution characteristics, or a drilling location or landing point for initiating or steering a wellbore. The drilling equipment may be directed along a wellbore trajectory to one or more identified locations in the reservoir (e.g., locations having a high probability of oil) as determined from the model output and/or predicted fluid distribution characteristics.

In some embodiments, the predicted one or more asphaltene cluster gradients and corresponding fluid distribution characteristics are not merely analytical outputs, but may be used to drive physical field operations. For example, results obtained from comparing the predicted asphaltene cluster gradients to observed data may be used to identify locations within the subsurface reservoir that are expected to exhibit favorable fluid properties, including, e.g., oil composition, viscosity, and connectivity. These identified locations may correspond to regions having a higher likelihood of producible hydrocarbons or reduced flow impairment due to asphaltene deposition.

In some embodiments, the identified locations within the reservoir may be used to generate one or more drilling parameters for a drilling operation. Such drilling parameters may include, by way of example and not limitation, a target depth, target interval, drilling direction, inclination, azimuth, and/or planned wellbore geometry. The drilling parameters may be generated automatically by a computing system executing the compositional reservoir simulation model, or semi-automatically with user input, based at least in part on the predicted fluid distribution characteristics derived from the modeling and comparison steps.

The generated drilling parameters may be provided to drilling equipment and used to perform a drilling operation in the subsurface reservoir. In such embodiments, drilling equipment may be operated in accordance with the drilling parameters to drill a wellbore into the reservoir, thereby effecting a physical change in the subsurface environment. The drilling operation may be performed during an exploration phase, an appraisal phase, or a field development phase, and may be carried out by an operator using drilling equipment and the drilling parameters derived from the modeling workflow described herein.

In some embodiments, the drilling parameters may include a planned wellbore trajectory. The wellbore trajectory may be defined to intersect one or more of the identified locations within the reservoir that are associated with favorable predicted fluid distribution characteristics. In such embodiments, the drilling equipment may be directed along the wellbore trajectory during the drilling operation, thereby steering the wellbore toward the identified locations based on the output of the compositional reservoir simulation model and the predicted asphaltene cluster gradients.

In this manner, the modeling workflow described with respect to FIG. 2 is integrated into a field development process by converting predicted asphaltene cluster gradients and fluid distribution characteristics into actionable drilling parameters that are used to perform drilling operations in the subsurface reservoir. This integration enables the use of reservoir-scale fluid charge modeling and asphaltene thermodynamics to influence physical well construction decisions, including where and how wells may be drilled within an oil field.

In some embodiments, predicted fluid distribution characteristics may be used to avoid ineffective or inefficient drilling and injection operations. For example, the presence of immobile asphaltene-rich zones or tar-like regions at an oil-water contact may be identified from predicted asphaltene cluster gradients. Such predictions may be used to avoid placement of water injectors or production wells in locations where fluid mobility is impaired, thereby reducing unnecessary drilling operations and improving field development efficiency.

As described herein, the disclosed embodiments extend beyond the mere acquisition or analysis of subsurface data. While observed measurements are used as inputs for comparison and validation, the technique described herein effects a physical change in the subsurface environment by converting modeling outputs into drilling parameters and using those parameters to perform drilling operations. Accordingly, the disclosed technique integrates computational modeling with physical well construction activities in the subsurface reservoir.

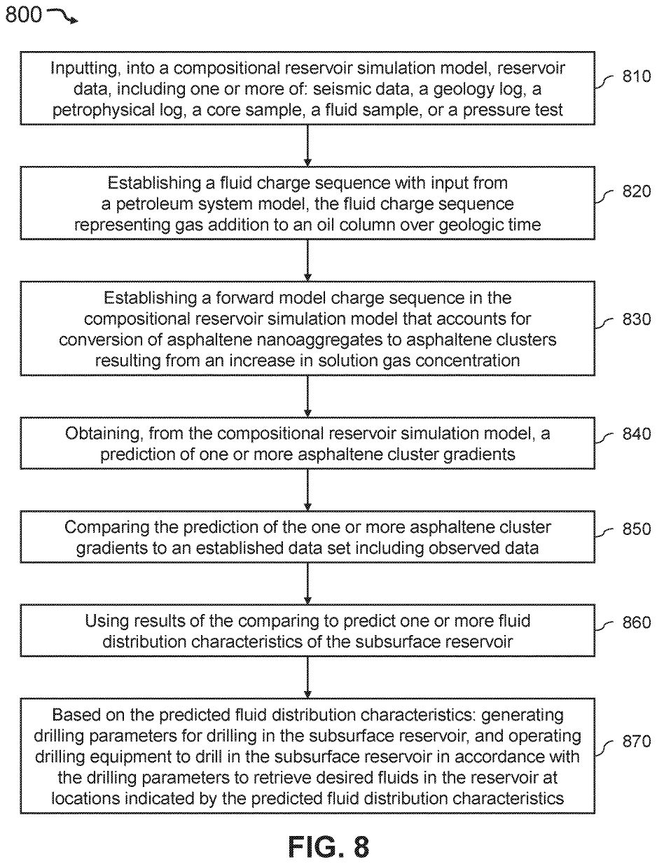

FIG. 8 is a flowchart for an example method.

In FIG. 8, an example computer-implemented method 800 for predicting asphaltene cluster gradients in a subsurface reservoir may include, at 810, inputting, into a compositional reservoir simulation model, reservoir data for a subsurface reservoir, the reservoir data including one or more of: seismic data, a geology log, a petrophysical log, a core sample, a fluid sample, or a pressure test. The example method 800 may further include, at 820, establishing a fluid charge sequence with input from a petroleum system model, the fluid charge sequence representing gas addition to an oil column over geologic time. The example method 800 may further include, at 830, establishing a forward model charge sequence in the compositional reservoir simulation model that accounts for conversion of asphaltene nanoaggregates to asphaltene clusters resulting from an increase in solution gas concentration. The example method 800 may further include, at 840, obtaining, from the compositional reservoir simulation model, a prediction of one or more asphaltene cluster gradients in the subsurface reservoir. The example method 800 may further include, at 850, comparing the prediction of the one or more asphaltene cluster gradients to an established data set including observed data. The example method 800 may further include, at 860, using results of the comparing to predict one or more fluid distribution characteristics of the subsurface reservoir. The example method 800 may further include, at 870, based at least in part on the predicted one or more fluid distribution characteristics: generating drilling parameters for drilling in the subsurface reservoir, and operating drilling equipment to drill in the subsurface reservoir in accordance with the drilling parameters to retrieve desired fluids in the subsurface reservoir at one or more locations indicated by the predicted one or more fluid distribution characteristics.

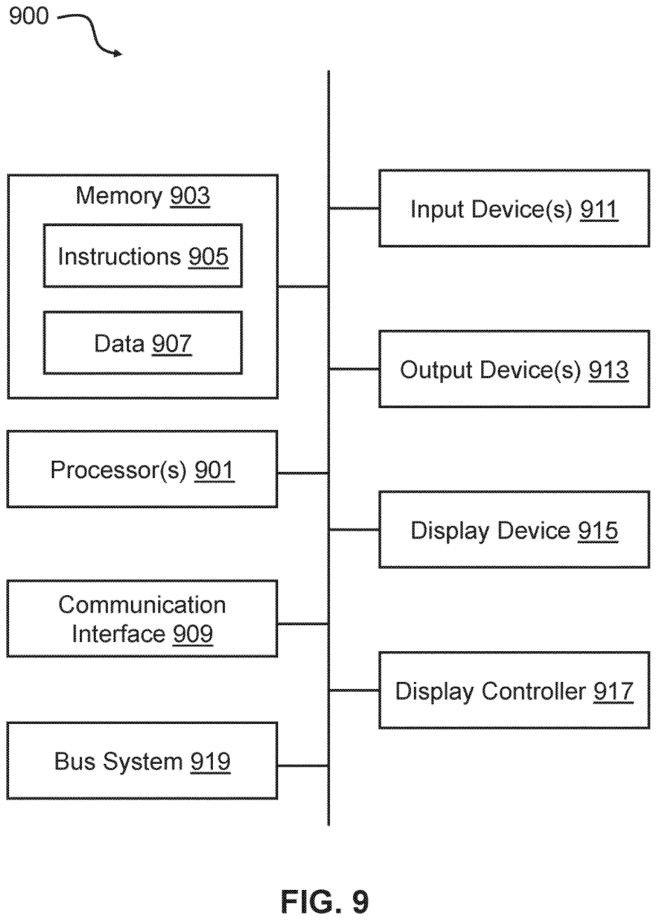

FIG. 9 illustrates certain components that may be included within a computer system according to an example embodiment of the present disclosure.

FIG. 9 illustrates certain components that may be included within a computer system 900, which may be used to control features according to embodiments of the present disclosure, such as the features discussed with reference to FIGS. 1-8. One or more computer systems 900 may be used to implement the various devices, components, and systems described herein.

The computer system 900 includes one or more processors 901. The processor(s) 901 may be a single processor or may include multiple processors and/or sub-processors. The processor(s) 901 may be a general-purpose single- or multi-chip microprocessor (e.g., an Advanced RISC (reduced instruction set computing) Machine (ARM)), a special-purpose microprocessor (e.g., a digital signal processor (DSP)), a microcontroller, a programmable gate array, etc. The processor(s) 901 may be referred to as a central processing unit (CPU). Although a single processor(s) 901 is shown in the computer system 900 of FIG. 9, in an alternative configuration, a combination of processors (e.g., an ARM and DSP) could be used. In one or more embodiments, the computer system 900 further includes one or more graphics processing units (GPUs), which can provide processing services related to both entity classification and graph generation.

The computer system 900 also includes memory 903 in electronic communication with the processor(s) 901. The memory 903 may be any electronic component capable of storing electronic information. For example, the memory 903 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, at least one non-transitory computer-readable and/or processor-readable medium, and so forth, including combinations thereof. The memory 903 may include a single memory device or multiple memory devices.

Instructions 905 and data 907 may be stored in the memory 903. The instructions 905 may be executable by the processor(s) 901 to implement some or all of the functionality disclosed herein. Executing the instructions 905 may involve the use of the data 907 that is stored in the memory 903. Any of the various examples of modules and components described herein may be implemented, partially or wholly, as instructions 905 stored in memory 903 and executed by the processor(s) 901. Any of the various examples of data described herein may be among the data 907 that is stored in memory 903 and used during execution of the instructions 905 by the processor(s) 901.

A computer system 900 may also include one or more communication interfaces 909 for communicating with other electronic devices. The communication interface(s) 909 may be based on wired communication technology, wireless communication technology, or both. Some examples of communication interfaces 909 include a Universal Serial Bus (USB), an Ethernet adapter, a wireless adapter that operates in accordance with an Institute of Electrical and Electronics Engineers (IEEE®) 802.11 wireless communication protocol, a BLUETOOTH® wireless communication adapter, and an infrared (IR) communication port.

A computer system 900 may also include one or more input devices 911 and one or more output devices 913. Some examples of input devices 911 include a keyboard, mouse, microphone, remote control device, button, joystick, trackball, touchpad, and lightpen. Some examples of output devices 913 include a speaker and a printer. One specific type of output device that is typically included in a computer system 900 is a display device 915. Display devices 915 used with embodiments disclosed herein may utilize any suitable image projection technology, such as liquid crystal display (LCD), light-emitting diode (LED), gas plasma, electroluminescence, or the like, and may be provided in any desired number. At least one display controller 917 may also be provided, for converting data 907 stored in the memory 903 into text, graphics, and/or moving images (as appropriate) shown on the display device 915.

The various components of the computer system 900 may be coupled together by one or more buses, which may include a power bus, a control signal bus, a status signal bus, a data bus, etc. For the sake of clarity, the various buses are illustrated in FIG. 9 as a bus system 919.

The following are sections in accordance with at least one embodiment of the present disclosure:

Clause 1: A computer-implemented method for predicting asphaltene cluster gradients in a subsurface reservoir, the method including: inputting, into a compositional reservoir simulation model, reservoir data for a subsurface reservoir, the reservoir data including one or more of: seismic data, a geology log, a petrophysical log, a core sample, a fluid sample, or a pressure test, establishing a fluid charge sequence with input from a petroleum system model, the fluid charge sequence representing gas addition to an oil column over geologic time, establishing a forward model charge sequence in the compositional reservoir simulation model that accounts for conversion of asphaltene nanoaggregates to asphaltene clusters resulting from an increase in solution gas concentration, obtaining, from the compositional reservoir simulation model, a prediction of one or more asphaltene cluster gradients in the subsurface reservoir, comparing the prediction of the one or more asphaltene cluster gradients to an established data set including observed data, using results of the comparing to predict one or more fluid distribution characteristics of the subsurface reservoir, and based at least in part on the predicted one or more fluid distribution characteristics: generating drilling parameters for drilling in the subsurface reservoir, and operating drilling equipment to drill in the subsurface reservoir in accordance with the drilling parameters to retrieve desired fluids in the subsurface reservoir at one or more locations indicated by the predicted one or more fluid distribution characteristics.

Clause 2: The computer-implemented method of clause 1, wherein: the establishing the forward model charge sequence includes coupling the conversion of asphaltene nanoaggregates to asphaltene clusters with a diffusion mechanism based on a chemical potential of components in the compositional reservoir simulation model, and the chemical potential accounts for gravity such that heavier asphaltene cluster components migrate toward a base of the oil column.

Clause 3: The computer-implemented method of clause 1, wherein: the gas addition includes adding methane to the oil column, and the conversion of asphaltene nanoaggregates to asphaltene clusters is triggered when a methane mole fraction reaches a threshold amount locally in the subsurface reservoir.

Clause 4: The computer-implemented method of clause 1, wherein the establishing the fluid charge sequence includes modeling biogenic gas being added at an oil-water contact (OWC) into the oil column over a scaled duration of at least about 100,000 years.

Clause 5: The computer-implemented method of clause 4, wherein: the compositional reservoir simulation model tracks changes in at least one of solution gas-oil ratio (GOR), oil saturation, or gas saturation over the scaled duration, and the model predicts formation of a separate gas phase, including a gas cap, after an oil phase becomes saturated with gas.

Clause 6: The computer-implemented method of clause 1, wherein using the results of the comparing to predict the one or more fluid distribution characteristics includes predicting at least one of: a distribution of asphaltene content, or a distribution of oil viscosity in the subsurface reservoir based on observed measurements of gas-oil ratio (GOR).

Clause 7: The computer-implemented method of clause 1, wherein the reservoir data is applied to a reservoir model representing a tilted-sheet sandstone reservoir, the reservoir model including: a top portion initially saturated with dead oil, and a bottom portion including a water aquifer.

Clause 8: One or more non-transitory computer-readable media storing instructions that, when executed by at least one processor of a computing system, cause the computing system to perform operations for predicting asphaltene cluster gradients in a subsurface reservoir, the operations including: inputting, into a compositional reservoir simulation model, reservoir data for a subsurface reservoir, the reservoir data including one or more of: seismic data, a geology log, a petrophysical log, a core sample, a fluid sample, or a pressure test, establishing a fluid charge sequence with input from a petroleum system model, the fluid charge sequence representing gas addition to an oil column over geologic time, establishing a forward model charge sequence in the compositional reservoir simulation model that accounts for conversion of asphaltene nanoaggregates to asphaltene clusters resulting from an increase in solution gas concentration, obtaining, from the compositional reservoir simulation model, a prediction of one or more asphaltene cluster gradients in the subsurface reservoir, comparing the prediction of the one or more asphaltene cluster gradients to an established data set including observed data, using results of the comparing to predict one or more fluid distribution characteristics of the subsurface reservoir, and based at least in part on the predicted one or more fluid distribution characteristics: generating drilling parameters for drilling in the subsurface reservoir, and operating drilling equipment to drill in the subsurface reservoir in accordance with the drilling parameters to retrieve desired fluids in the subsurface reservoir at one or more locations indicated by the predicted one or more fluid distribution characteristics.

Clause 9: The one or more non-transitory computer-readable media of clause 8, wherein: the establishing the forward model charge sequence includes coupling the conversion of asphaltene nanoaggregates to asphaltene clusters with a diffusion mechanism based on a chemical potential of components in the compositional reservoir simulation model, and the chemical potential accounts for gravity such that heavier asphaltene cluster components migrate toward a base of the oil column.

Clause 10: The one or more non-transitory computer-readable media of clause 8, wherein: the gas addition includes adding methane to the oil column, and the conversion of asphaltene nanoaggregates to asphaltene clusters is triggered when a methane mole fraction reaches a threshold amount locally in the subsurface reservoir.

Clause 11: The one or more non-transitory computer-readable media of clause 8, wherein: the establishing the fluid charge sequence includes modeling biogenic gas being added at an oil-water contact (OWC) into the oil column over a scaled duration of at least about 100,000 years, the compositional reservoir simulation model tracks changes in at least one of solution gas-oil ratio (GOR), oil saturation, or gas saturation over the scaled duration, and the model is configured to predict formation of a separate gas phase, including a gas cap, after an oil phase becomes saturated with gas.

Clause 12: The one or more non-transitory computer-readable media of clause 8, wherein using the results of the comparing to predict the one or more fluid distribution characteristics includes predicting at least one of: a distribution of asphaltene content, or a distribution of oil viscosity in the subsurface reservoir based on observed measurements of gas-oil ratio (GOR).

Clause 13: The one or more non-transitory computer-readable media of clause 8, wherein the reservoir data is applied to a reservoir model representing a tilted-sheet sandstone reservoir, the reservoir model including: a top portion initially saturated with dead oil, and a bottom portion including a water aquifer.

Clause 14: A system, including: one or more processors, and at least one memory including at least one non-transitory computer-readable medium storing instructions that, when executed by at least one of the one or more processors, cause the system to perform operations for predicting asphaltene cluster gradients in a subsurface reservoir, the operations including: inputting, into a compositional reservoir simulation model, reservoir data for a subsurface reservoir, the reservoir data including one or more of: seismic data, a geology log, a petrophysical log, a core sample, a fluid sample, or a pressure test, establishing a fluid charge sequence with input from a petroleum system model, the fluid charge sequence representing gas addition to an oil column over geologic time, establishing a forward model charge sequence in the compositional reservoir simulation model that accounts for conversion of asphaltene nanoaggregates to asphaltene clusters resulting from an increase in solution gas concentration, obtaining, from the compositional reservoir simulation model, a prediction of one or more asphaltene cluster gradients in the subsurface reservoir, comparing the prediction of the one or more asphaltene cluster gradients to an established data set including observed data, using results of the comparing to predict one or more fluid distribution characteristics of the subsurface reservoir, and based at least in part on the predicted one or more fluid distribution characteristics: generating drilling parameters for drilling in the subsurface reservoir, and operating drilling equipment to drill in the subsurface reservoir in accordance with the drilling parameters to retrieve desired fluids in the subsurface reservoir at one or more locations indicated by the predicted one or more fluid distribution characteristics.

Clause 15: The system of clause 14, wherein: the establishing the forward model charge sequence includes coupling the conversion of asphaltene nanoaggregates to asphaltene clusters with a diffusion mechanism based on a chemical potential of components in the compositional reservoir simulation model, and the chemical potential accounts for gravity such that heavier asphaltene cluster components migrate toward a base of the oil column.

Clause 16: The system of clause 14, wherein: the gas addition includes adding methane to the oil column, and the conversion of asphaltene nanoaggregates to asphaltene clusters is triggered when a methane mole fraction reaches a threshold amount locally in the subsurface reservoir.

Clause 17: The system of clause 14, wherein the establishing the fluid charge sequence includes modeling biogenic gas being added at an oil-water contact (OWC) into the oil column over a scaled duration of at least about 100,000 years.

Clause 18: The system of clause 17, wherein: the compositional reservoir simulation model tracks changes in at least one of solution gas-oil ratio (GOR), oil saturation, or gas saturation over the scaled duration, and the model is configured to predict formation of a separate gas phase, including a gas cap, after an oil phase becomes saturated with gas.

Clause 19: The system of clause 14, wherein using the results of the comparing to predict the one or more fluid distribution characteristics includes predicting at least one of: a distribution of asphaltene content, or a distribution of oil viscosity in the subsurface reservoir based on observed measurements of gas-oil ratio (GOR).

Clause 20: The system of clause 14, wherein the reservoir data is applied to a reservoir model representing a tilted-sheet sandstone reservoir, the reservoir model including: a top portion initially saturated with dead oil, and a bottom portion including a water aquifer.

Systems and software, e.g., implemented on a non-transitory computer-readable medium, for performing the methods discussed herein are also within the scope of embodiments of the present disclosure.

Embodiments of the present disclosure may thus utilize a special-purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general-purpose or special-purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media or transmission media. Combinations of physical storage media and transmission media should also be included within the scope of computer-readable media.

Both physical storage media and transmission media may be used to temporarily store or carry software instructions in the form of computer-readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HD DVD, Blu-ray, etc.), storage devices (e.g., magnetic disk storage, tape storage, diskette, etc.), flash or other solid-state storage or memory, or any other non-transmission medium, which can be used to store program code in the form of computer-executable instructions or data structures and can be accessed by a general-purpose or special-purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either wired, wireless, or a combination of wired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and can be accessed by a general-purpose or special-purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers'specific goals, such as compliance with system-related and business-related constraints, which may vary from one embodiment to another. Moreover, it should be appreciated that such a development effort might be complex and time-consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about,” “~”, or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize, in view of the present disclosure, that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses, are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words “means for” appear together with an associated function. Each addition, deletion, and modification to the embodiments that falls within the meaning and scope of the claims is to be embraced by the claims. Any trademarks mentioned herein are the property of their respective owners. Example embodiments are not limited to any particularly-mentioned products, trademarks, or properties.

The terms “approximately,” “about,” “substantially,” and “~” as used herein represent an amount close to the stated amount that still performs a desired function or achieves a desired result. For example, the terms “approximately,” “about,” “substantially,” and “~” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A computer-implemented method for predicting asphaltene cluster gradients in a subsurface reservoir, the method comprising:
inputting, into a compositional reservoir simulation model, reservoir data for a subsurface reservoir, the reservoir data comprising one or more of: seismic data, a geology log, a petrophysical log, a core sample, a fluid sample, or a pressure test;
establishing a fluid charge sequence with input from a petroleum system model, the fluid charge sequence representing gas addition to an oil column over geologic time;
establishing a forward model charge sequence in the compositional reservoir simulation model that accounts for conversion of asphaltene nanoaggregates to asphaltene clusters resulting from an increase in solution gas concentration;
obtaining, from the compositional reservoir simulation model, a prediction of one or more asphaltene cluster gradients in the subsurface reservoir;
comparing the prediction of the one or more asphaltene cluster gradients to an established data set comprising observed data;
using results of the comparing to predict one or more fluid distribution characteristics of the subsurface reservoir; and
based at least in part on the predicted one or more fluid distribution characteristics:
generating drilling parameters for drilling in the subsurface reservoir; and
operating drilling equipment to drill in the subsurface reservoir in accordance with the drilling parameters to retrieve desired fluids in the subsurface reservoir at one or more locations indicated by the predicted one or more fluid distribution characteristics.

2. The computer-implemented method of claim 1, wherein:
the establishing the forward model charge sequence comprises coupling the conversion of asphaltene nanoaggregates to asphaltene clusters with a diffusion mechanism based on a chemical potential of components in the compositional reservoir simulation model; and
the chemical potential accounts for gravity such that heavier asphaltene cluster components migrate toward a base of the oil column.

3. The computer-implemented method of claim 1, wherein:
the gas addition comprises adding methane to the oil column; and
the conversion of asphaltene nanoaggregates to asphaltene clusters is triggered when a methane mole fraction reaches a threshold amount locally in the subsurface reservoir.

4. The computer-implemented method of claim 1, wherein the establishing the fluid charge sequence comprises modeling biogenic gas being added at an oil-water contact (OWC) into the oil column over a scaled duration of at least about 100,000 years.

5. The computer-implemented method of claim 4, wherein:
the compositional reservoir simulation model tracks changes in at least one of solution gas-oil ratio (GOR), oil saturation, or gas saturation over the scaled duration; and
the model predicts formation of a separate gas phase, including a gas cap, after an oil phase becomes saturated with gas.

6. The computer-implemented method of claim 1, wherein using the results of the comparing to predict the one or more fluid distribution characteristics comprises predicting at least one of:
a distribution of asphaltene content; or
a distribution of oil viscosity in the subsurface reservoir based on observed measurements of gas-oil ratio (GOR).

7. The computer-implemented method of claim 1, wherein the reservoir data is applied to a reservoir model representing a tilted-sheet sandstone reservoir, the reservoir model comprising:
a top portion initially saturated with dead oil; and
a bottom portion comprising a water aquifer.

8. One or more non-transitory computer-readable media storing instructions that, when executed by at least one processor of a computing system, cause the computing system to perform operations for predicting asphaltene cluster gradients in a subsurface reservoir, the operations comprising:
inputting, into a compositional reservoir simulation model, reservoir data for a subsurface reservoir, the reservoir data comprising one or more of: seismic data, a geology log, a petrophysical log, a core sample, a fluid sample, or a pressure test;
establishing a fluid charge sequence with input from a petroleum system model, the fluid charge sequence representing gas addition to an oil column over geologic time;
establishing a forward model charge sequence in the compositional reservoir simulation model that accounts for conversion of asphaltene nanoaggregates to asphaltene clusters resulting from an increase in solution gas concentration;
obtaining, from the compositional reservoir simulation model, a prediction of one or more asphaltene cluster gradients in the subsurface reservoir;
comparing the prediction of the one or more asphaltene cluster gradients to an established data set comprising observed data;
using results of the comparing to predict one or more fluid distribution characteristics of the subsurface reservoir; and
based at least in part on the predicted one or more fluid distribution characteristics:
generating drilling parameters for drilling in the subsurface reservoir; and
operating drilling equipment to drill in the subsurface reservoir in accordance with the drilling parameters to retrieve desired fluids in the subsurface reservoir at one or more locations indicated by the predicted one or more fluid distribution characteristics.

9. The one or more non-transitory computer-readable media of claim 8, wherein:
the establishing the forward model charge sequence comprises coupling the conversion of asphaltene nanoaggregates to asphaltene clusters with a diffusion mechanism based on a chemical potential of components in the compositional reservoir simulation model; and
the chemical potential accounts for gravity such that heavier asphaltene cluster components migrate toward a base of the oil column.

10. The one or more non-transitory computer-readable media of claim 8, wherein:
the gas addition comprises adding methane to the oil column; and
the conversion of asphaltene nanoaggregates to asphaltene clusters is triggered when a methane mole fraction reaches a threshold amount locally in the subsurface reservoir.

11. The one or more non-transitory computer-readable media of claim 8, wherein:
the establishing the fluid charge sequence comprises modeling biogenic gas being added at an oil-water contact (OWC) into the oil column over a scaled duration of at least about 100,000 years;
the compositional reservoir simulation model tracks changes in at least one of solution gas-oil ratio (GOR), oil saturation, or gas saturation over the scaled duration; and
the model is configured to predict formation of a separate gas phase, including a gas cap, after an oil phase becomes saturated with gas.

12. The one or more non-transitory computer-readable media of claim 8, wherein using the results of the comparing to predict the one or more fluid distribution characteristics comprises predicting at least one of:
a distribution of asphaltene content; or
a distribution of oil viscosity in the subsurface reservoir based on observed measurements of gas-oil ratio (GOR).

13. The one or more non-transitory computer-readable media of claim 8, wherein the reservoir data is applied to a reservoir model representing a tilted-sheet sandstone reservoir, the reservoir model comprising:
a top portion initially saturated with dead oil; and
a bottom portion comprising a water aquifer.

14. A system, comprising:
one or more processors; and
at least one memory comprising at least one non-transitory computer-readable medium storing instructions that, when executed by at least one of the one or more processors, cause the system to perform operations for predicting asphaltene cluster gradients in a subsurface reservoir, the operations comprising:
inputting, into a compositional reservoir simulation model, reservoir data for a subsurface reservoir, the reservoir data comprising one or more of: seismic data, a geology log, a petrophysical log, a core sample, a fluid sample, or a pressure test;
establishing a fluid charge sequence with input from a petroleum system model, the fluid charge sequence representing gas addition to an oil column over geologic time;
establishing a forward model charge sequence in the compositional reservoir simulation model that accounts for conversion of asphaltene nanoaggregates to asphaltene clusters resulting from an increase in solution gas concentration;
obtaining, from the compositional reservoir simulation model, a prediction of one or more asphaltene cluster gradients in the subsurface reservoir;
comparing the prediction of the one or more asphaltene cluster gradients to an established data set comprising observed data;
using results of the comparing to predict one or more fluid distribution characteristics of the subsurface reservoir; and
based at least in part on the predicted one or more fluid distribution characteristics:
generating drilling parameters for drilling in the subsurface reservoir; and
operating drilling equipment to drill in the subsurface reservoir in accordance with the drilling parameters to retrieve desired fluids in the subsurface reservoir at one or more locations indicated by the predicted one or more fluid distribution characteristics.

15. The system of claim 14, wherein:
the establishing the forward model charge sequence comprises coupling the conversion of asphaltene nanoaggregates to asphaltene clusters with a diffusion mechanism based on a chemical potential of components in the compositional reservoir simulation model; and
the chemical potential accounts for gravity such that heavier asphaltene cluster components migrate toward a base of the oil column.

16. The system of claim 14, wherein:
the gas addition comprises adding methane to the oil column; and
the conversion of asphaltene nanoaggregates to asphaltene clusters is triggered when a methane mole fraction reaches a threshold amount locally in the subsurface reservoir.

17. The system of claim 14, wherein the establishing the fluid charge sequence comprises modeling biogenic gas being added at an oil-water contact (OWC) into the oil column over a scaled duration of at least about 100,000 years.

18. The system of claim 17, wherein:
the compositional reservoir simulation model tracks changes in at least one of solution gas-oil ratio (GOR), oil saturation, or gas saturation over the scaled duration; and
the model is configured to predict formation of a separate gas phase, including a gas cap, after an oil phase becomes saturated with gas.

19. The system of claim 14, wherein using the results of the comparing to predict the one or more fluid distribution characteristics comprises predicting at least one of:
a distribution of asphaltene content; or
a distribution of oil viscosity in the subsurface reservoir based on observed measurements of gas-oil ratio (GOR).

20. The system of claim 14, wherein the reservoir data is applied to a reservoir model representing a tilted-sheet sandstone reservoir, the reservoir model comprising:
a top portion initially saturated with dead oil; and
a bottom portion comprising a water aquifer.
